(19) United States
(12) Patent Application Publication
(10) Pub. No.: US 2014/0148119 A1
(43) Pub. Date: May 29, 2014

(54) Emergency (SOS) Mode Enhancements for Cellular Networks

(71) Applicant: BROADCOM CORPORATION, Irvine, CA (US)

(72) Inventors: Erik STAUFFER, Mountain View, CA (US); Djordje TUJKOVIC, Mountain View, CA (US); Hyunn Jong YANG, Sunnyvale, CA (US); Kamlesh RATH, San Ramon, CA (US); Shao-Cheng WANG, Santa Clara, CA (US); Robert LORENZ, Menlo Park, CA (US); Pavan NUGGEHALLI, Mountain View, CA (US); Soumen CHAKRABORTY, Bangalore (IN)

(73) Assignee: Broadcom Corporation, Irvine, CA (US)

(21) Appl. No.: 13/838,620

(22) Filed: Mar. 15, 2013

Related U.S. Application Data
(60) Provisional application No. 61/731,158, filed on Nov. 29, 2012.

(51) Int. Cl. H04W 4/22

(52) U.S. Cl. CPC H04W 4/22
USPC 455/404.1

(57) ABSTRACT

Systems and methods for enabling a group of user equipments located in an emergency area to cooperatively transmit an emergency (SOS) message to a cellular network and to cooperatively receive an SOS message (or response) from the cellular network are provided. Embodiments further provide a scheme for enabling dedicated receivers, and/or user equipments that are attached to the cellular network to serve as relay stations for SOS messages, thereby extending the coverage of the cellular network to the emergency area.

### CROSS-REFERENCE TO RELATED APPLICATIONS

The present application claims the benefit of U.S. Provisional Application No. 61/731,158, filed Nov. 29, 2012, which is incorporated herein by reference in its entirety.

The present application is related to U.S. application Ser. No. TBD, filed Mar. 15, 2013, titled “Synchronous SOS Messaging in a Cellular Network” (Attorney Docket No. 3875.6720001), which is incorporated herein by reference in its entirety.

### FIELD OF THE INVENTION

The present disclosure relates generally to emergency (SOS) messaging in wireless access communication networks.

### BACKGROUND

### Background Art

Emergency situations commonly occur around the globe, putting millions of lives at risk. A cellular network offers a unique and important opportunity to protect people during times of crisis and emergency. The 3^{rd} Generation Partnership Project (3GPP) offers an Earthquake and Tsunami Waning System (ETWS), which enables delivery of critical information to User Equipments (UEs) within the cellular coverage zone, drastically reducing the amount of time required to warn users of an impending disaster.

While the ETWS system is able to distribute emergency and early warning information before a disaster, it does not enable delivering emergency information in the reverse direction, from a UE to the network, which would allow a user to identify itself as in need of emergency assistance. One design challenge is that network coverage is commonly poor in the location where the emergency event occurs (e.g., due to infrastructure being damaged due to the emergency event, or if the emergency event occurs at the radio cell edge or outside of the coverage area).

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 illustrates an example environment in which embodiments can be used or implemented.

FIG. 2 illustrates an example SOS coordination process according to an embodiment.

FIG. 3 is an example process for cooperatively transmitting an emergency (SOS) message to a cellular network according to an embodiment.

FIG. 4 is another example process for cooperatively transmitting an SOS message to a cellular network according to an embodiment.

FIG. 5 is another example process for cooperatively transmitting an SOS message to a cellular network according to an embodiment.

FIG. 6 illustrates an example user equipment (UE) according to an embodiment.

FIG. 7 is an example process for cooperatively receiving an SOS message from a cellular network by an SOS group according to an embodiment.

FIG. 8 is an example process for enabling a UE to relay an SOS message to a cellular network according to an embodiment.

The present disclosure will be described with reference to the accompanying drawings. Generally, the drawing in which an element first appears is typically indicated by the leftmost digit(s) in the corresponding reference number.

### DETAILED DESCRIPTION OF EMBODIMENTS

In the following disclosure, terms defined by the Long-Term Evolution (LTE) standard are sometimes used. For example, the term “eNodeB” is used to refer to what is commonly described as base station (BS) or base transceiver station (BTS) in other standards. The term “User Equipment (UE)” is used to refer to what is commonly described as a mobile station (MS) or mobile terminal in other standards. However, as will be apparent to a person of skill in the art based on the teachings herein, embodiments are not limited to the LTE standard and can be applied to other wireless communication standards.

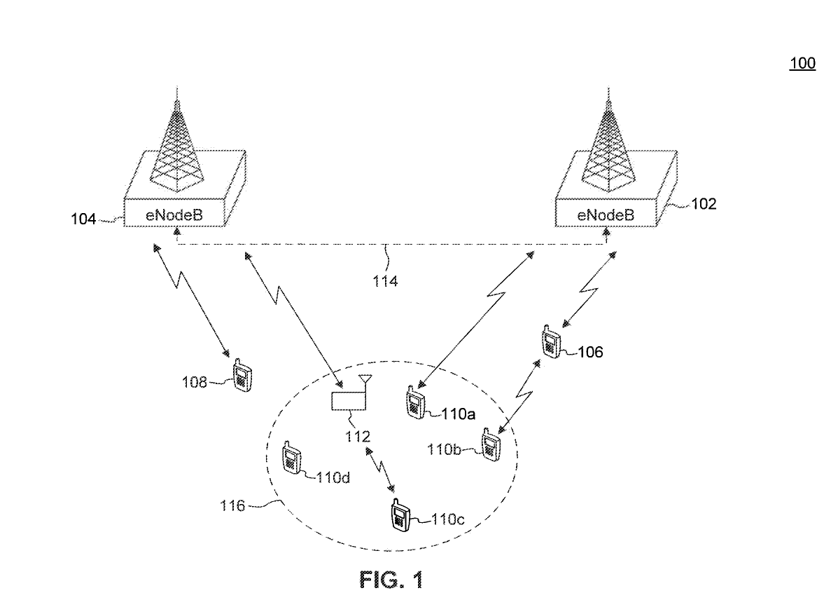

FIG. 1 illustrates an example environment 100 in which embodiments can be used or implemented. Example environment 100 is provided for the purpose of illustration only and is not limiting of embodiments. As will be apparent to a person of skill in the art, embodiments are not limited to cellular networks and may be applied to other kinds of wireless access communication networks.

As shown in FIG. 1, example network environment 100 includes a first Evolved Node B (eNodeB) 102, a second eNodeB 104, User Equipments (UEs) 106, 108, and 110a-d, and a dedicated SOS receiver 112. eNodeB 102 and eNodeB 104 may communicate via a backhaul network (e.g., X2 interface) link 114. eNodeBs 102 and 104 may each support a plurality of cells (each cell is the equivalent of a base station and has a unique cell ID that identifies it to UEs). Depending on its receiver capabilities, a UE may communicate with one or more cells of eNodeB 102 and/or eNodeB 104. UEs 106, 108, and 110a-d can be any wireless device capable of cellular-based communication, including a cellular phone, tablet, laptop, etc.

Dedicated receiver 112 includes any receiver capable of receiving and decoding transmissions from UEs. For example, dedicated receiver 112 can be configured to receive SOS messages from the UEs. Dedicated receiver 112 can be fixed or mobile. For example, dedicated receiver 112 can be dropped into area 116 or can be mounted on a moving vessel, such as an emergency response vehicle or helicopter, to listen for SOS message transmissions.

For the purpose of illustration of embodiments, it is assumed that UE 106 is served by a cell located at eNodeB 102 and that UE 108 is served by a cell located at eNodeB 104. This means that UEs 106 and UE 108 are attached to the cellular network, including being able to receive and decode the downlink control channels of their respective serving cells (within a predetermined period of time defined by the relevant communication standard) and to synchronize themselves with their respective serving cells.

UEs 110a-d and dedicated SOS receiver 112 are located in an area 116, in which an emergency situation has occurred. Due to the emergency situation, some of UEs 110a-d may be outside the coverage of the cellular network. For example, the emergency situation could have resulted in damage to the cellular network infrastructure leading to some of UEs 110a-d being outside the coverage of the cellular network. This means that some of UEs 110a-d may be unable to attach themselves to the cellular network and therefore may be unable to communicate directly with the cellular network. In commonly owned U.S. patent application Ser. No. TBD, filed Mar. 15, 2013, titled “Synchronous SOS Messaging in a Cellular Network,” (Attorney Docket. No. 3875.6720001), methods and systems for enabling an unattached UE to transmit an SOS message to a cellular network, as well as highly robust transmission and reception schemes for the SOS message, are disclosed.

The emergency situation in area 116 may also cause high path loss between the cellular network and some of UEs 110a-d. As a result, transmissions from the cellular network may be highly attenuated and not decodable by some of UEs 110a-d. In addition, the cellular network may be unable to decode transmissions from some of UEs 110a-d. Thus, even if a UE is able to transmit an SOS message in a robust manner, the cellular network may be unable to receive and decode the SOS message successfully due to the high path loss. This is particularly the case when a large number of UEs, such as UEs 110a-d, attempt all at once to send SOS messages to the cellular network.

Embodiments, as further described below, provide systems and methods for enabling a group of UEs located in an emergency area, such as UEs 110a-d, to cooperatively transmit an SOS message to the cellular network and to cooperatively receive an SOS message (or response) from the cellular network. This increases the probability that the SOS message is received successfully by the cellular network, and that the SOS message from the network is received successfully by at least one UE of the group of UEs. Embodiments further provide a scheme for enabling dedicated receivers, such as receiver 112, and/or UEs that are attached to the cellular network, such as UEs 106 and 108, to serve as relay stations for SOS messages, thereby extending the coverage of the cellular network to the emergency area.

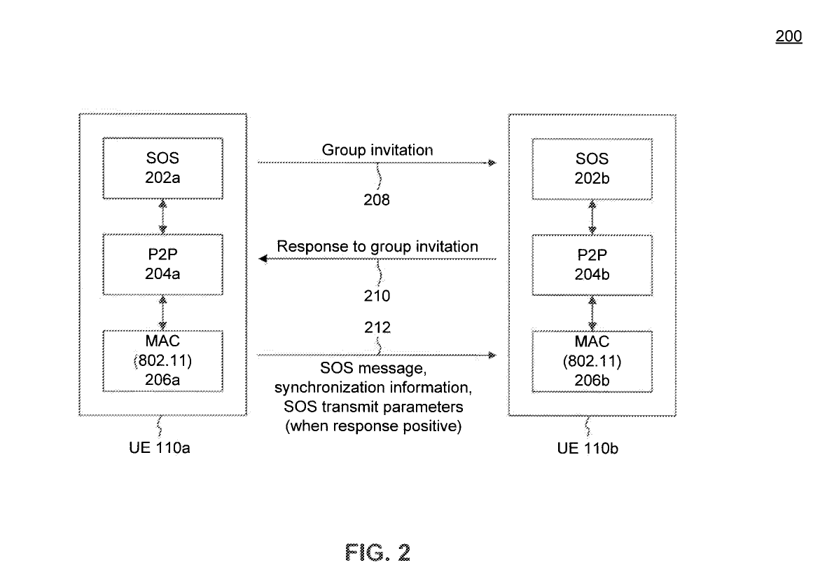

In one aspect of embodiments, a group of UEs located in proximity to each other, such as UEs 110a-d, can coordinate to form an SOS group and then to transmit cooperatively using the formed SOS group. FIG. 2 illustrates an example SOS coordination process 200 according to an embodiment. Example process 200 is provided for the purpose of illustration only and is not limiting of embodiments. Example process 200 can be used to form an SOS group according to embodiments. For the purpose of illustration only, example process 200 is described as being performed by UEs 110a and 110b of example environment 100 described with reference to FIG. 1 above.

In an embodiment, as shown in FIG. 2, each of UEs 110a and 110b includes an SOS application 202, a peer-to-peer (P2P) communication module 204, and a MAC layer module 206. SOS application 202 can be a mobile application designed for sending SOS messages. In an embodiment, SOS application 202 is only accessible by the user when the UE is outside network coverage and therefore unable to perform normal communication. P2P communication module 204 enables P2P communication between UEs. In an embodiment, P2P communication module 204 enables the UE to discover other nearby devices and to establish point-to-point communication links with them. For example, P2P communication module 204 can include a WiFi Direct module. MAC layer module 206 can implement an IEEE 802.11 medium access control (MAC) layer.

In an embodiment, upon launching SOS application 202 to send an SOS message, the user is prompted to select whether or not to transmit the SOS message cooperatively with nearby devices. If the user selection is to transmit the SOS message cooperatively, P2P communication module 204, using MAC layer module 206, searches for nearby devices and returns a list of nearby devices to SOS application 202. If the list is not empty, the user can select one or more of the nearby devices to invite to join an SOS group in order to transmit the SOS message cooperatively to the cellular network. In an embodiment, the user is also prompted whether or not to act as a group owner for the SOS group. In another embodiment, the selection of one or more nearby devices to invite to join the SOS group is done automatically without user input.

In an embodiment, as shown in FIG. 2, upon discovering UE 110b, UE 110a sends a group invitation to UE 110b in step 208. UE 110b accepts the group invitation by sending a response to the group invitation in step 210 to UE 110a. In another embodiment, UEs 110a and 110b perform a negotiation to appoint a group owner for the SOS group.

Subsequently, in step 212, UE 110a sends the SOS message, synchronization information, and SOS transmit parameters to UE 110b. In an embodiment, the SOS message includes an emergency message describing the nature of the emergency and/or the assistance needed and Global Navigation Satellite System (GNSS) coordinates of UE 110a. The synchronization information includes information for enabling UE 110b to time/frequency synchronize itself with UE 110a. The SOS transmit parameters can include any parameter used for transmitting the SOS message, including, for example, a transmission time, transmit frequency resources, a power level, a channel coding scheme, a modulation scheme, and/or an incremental redundancy (IR) version. In an embodiment, some of the SOS transmit parameters are selected from a fixed set of parameters. For example, different SOS message types (e.g., based on different levels of SOS severity) can be predefined and some of the SOS transmit parameters can be selected responsive to selecting the SOS message type.

In an embodiment, UEs 110a and 110b perform a negotiation regarding the content of the SOS message before transmitting the SOS message. UEs 110a and 110b can also perform a negotiation regarding the SOS transmit parameters before transmitting the SOS message. In another embodiment, the SOS message and SOS transmit parameters are determined solely by the group owner and other members of the SOS group abide by the group owner's determination.

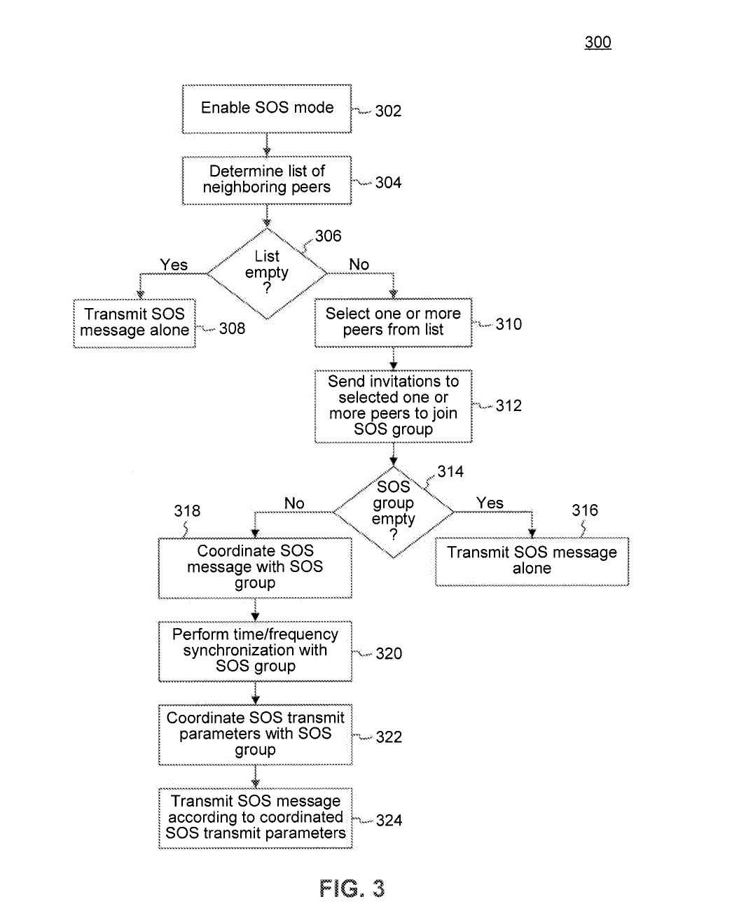

FIG. 3 is an example process 300 for cooperatively transmitting an SOS message to a cellular network according to an embodiment. Example process 300 is provided for the purpose of illustration only and is not limiting of embodiments. Example process 300 can be performed by a UE, such as one of UEs 110a-d described with reference to FIG. 1 above.

As shown in FIG. 3, example process 300 begins in step 302, which includes enabling SOS mode. In an embodiment, step 302 includes launching an SOS application, such as SOS application 202 described with reference to FIG. 2 above. Subsequently, in response to enabling the SOS mode, process 300 proceeds to step 304, which includes determining a list of neighboring peers. In an embodiment, step 304 is performed by a P2P communication module, such as P2P communication module 204 described with reference to FIG. 2 above, to discover neighboring devices with which an SOS group can be formed.

Step 306 includes determining whether or not the determined list of neighboring peers is empty. If the list is empty, process 300 proceeds to step 308, which includes transmitting the SOS message alone, without cooperating with other devices. In an embodiment, step 308 further includes increasing a maximum number of Hybrid Automatic Repeat Request (HARQ) retransmissions that the UE can attempt in transmitting to the network. For example, the maximum number of HARQ retransmissions can be increased above what is allowed by the relevant standard. Otherwise, process 300 proceeds to step 310, which includes selecting one or more peers from the list of neighboring peers, and then to step 312, which includes sending invitations to the selected one or more peers to join an SOS group.

Subsequently, in step 314, process 300 includes determining whether or not the SOS group is empty. The SOS group can be empty if the UE does not receive a response accepting the SOS group invitation from any of the peers invited in step 312. If the SOS group is empty, process 300 proceeds to step 316, which includes transmitting the SOS message alone, without cooperating with other devices. In an embodiment, step 316 further includes increasing a maximum number of HARQ retransmissions that the UE can attempt in transmitting to the network. For example, the maximum number of HARQ retransmissions can be increased above what is allowed by the relevant standard. Otherwise, if the SOS group is not empty, process 300 proceeds to step 318, which includes coordinating the SOS message with the SOS group. In an embodiment, step 318 includes sending the SOS message to at least one member of the SOS group. In an embodiment, the SOS message includes GNSS location coordinates of at least one member of the SOS group. For example, the GNSS coordinates of the group owner can be included in the SOS message. In another embodiment, step 318 farther includes receiving a response regarding the SOS message from at least one member of the SOS group. The response can include suggested modifications to the content of the SOS message.

Once the SOS message coordination is finished in step 318, process 300 proceeds to step 320, which includes performing at least one of time synchronization and frequency synchronization with at least one member of the SOS group. Time and/or frequency synchronization among members of the SOS group allows group members to coordinate transmissions in time and/or frequency to enhance the probability of successful detection of the SOS message by the network.

Additionally, time and/or frequency synchronization with the cellular network and/or to a reference time can be useful because it allows the SOS group to transmit the SOS message synchronously (in an allotted time and/or over allocated frequency resources) to the network, reducing the probability that the SOS message collides with transmissions from other users of the network. Further description regarding systems and methods for transmitting an SOS message synchronously to the network, without attachment to the network, can be found in commonly owned U.S. patent application Ser. No. TBD, filed Mar. 15, 2013, titled “Synchronous SOS Messaging in a Cellular Network,” (Attorney Docket. No. 3875.6720001), which is incorporated herein by reference in its entirety.

Accordingly, in an embodiment, step 320 further includes selecting a member of the SOS group to time/frequency synchronize itself with the cellular network, and then performing time/frequency synchronization with the selected member. For example, the group member with the largest signal-to-noise ratio (SNR) of network signals can be selected to attempt to synchronize itself with the cellular network by long time averaging signals from the network (long time averaging includes that the UE spends a larger than normal amount of time averaging signals from the network until it is able to successfully decode the signals). If the selected group member is successful, then the group owner can synchronize itself to the selected group member and then perform time/frequency synchronization with any other group members.

In another embodiment, step 320 further includes selecting a member of the SOS group that is time/frequency synchronized to a reference time (e.g., UTC, GNSS time, etc.), and then performing time/frequency synchronization with the selected member. For example, a group member may be capable of time/frequency synchronization to a non-cellular signal (e.g., GNSS signal, atomic clock broadcast signal, etc.). As such, the group owner can synchronize itself to this group member and then perform time/frequency synchronization with any other group members.

Subsequently, process 300 proceeds to step 322, which includes coordinating SOS transmit parameters with the SOS group. SOS transmit parameters, according to embodiments, can include any parameter used for transmitting the SOS message, including, for example, a transmission time, transmit frequency resources, a power level, a channel coding scheme, a modulation scheme, and/or an incremental redundancy (IR) version. The transmission time indicates the time at which a group member begins transmitting the SOS message. The transmit frequency resources indicate the carrier frequency and/or sub-carriers used to transmit the SOS message. The power level indicates the transmit power level with which the SOS message is transmitted. The channel coding scheme indicates the type/rate of the error detection/correction scheme used in transmitting the SOS message. The modulation scheme indicates the type of symbol mapping used in transmitting the SOS message. The IR version indicates a sequence according to which the SOS message is transmitted by a UE, defining at each transmission interval the portion of the SOS message to be transmitted. Group members with the same IR version transmit simultaneously or substantially simultaneously the same portions of the SOS message (pure redundancy). Group members with different IR version transmit simultaneously or substantially simultaneously different portions of the SOS message (some or no redundancy).

In an embodiment, step 322 further includes exchanging capabilities (e.g., power level range, channel coding schemes, modulation schemes, etc.) among the SOS group. For example, each member of the group can communicate its capabilities to the group owner, which uses the capabilities in determining the SOS transmit parameters. In an embodiment, step 322 includes determining common SOS transmit parameters for the SOS group. In another embodiment, step 322 includes determining member-specific SOS transmit parameters, which may be the same or different among group members. The coordinated SOS transmit parameters can be determined solely by the group owner or by coordination among the SOS group. In an embodiment, the coordinated SOS transmit parameters can include excluding one or more members of the SOS group from transmitting the SOS message (e.g., due to low battery level) or selecting a single group member to transmit the SOS message (e.g., at maximum power, low rate coding, low order modulation, etc.). For example, with reference to FIG. 1, UEs 110a-d can select UE 110a to transmit the SOS message to the cellular network. UE 110a may be closest to a base station such that it is able to attach itself to the network, for example.

In an embodiment, the coordinated SOS transmit parameters can be allowed to depart from the current relevant communication standard (e.g., LTE standard) or the current relevant standard can be modified to accommodate embodiments. For example, ore or more members of the SOS group may be allowed to transmit at a higher power than allowed by the relevant standard (or the relevant standard can be modified to accommodate such higher power transmission during SOS), or with a lower coding rate (higher redundancy) than required to maintain a minimum data throughput according to the relevant standard (or the relevant standard can be modified to accommodate such low coding rate during SOS), for example. In another embodiment, the SOS transmit parameters also include a maximum number of Hybrid Automatic Repeat Request (HARQ) retransmissions that a UE can attempt in transmitting to or receiving from the network, and the coordinated SOS transmit parameters (for group members that are attached to the network) can be allowed to depart from the relevant standard by using a higher number of HARQ retransmissions for the SOS message than allowed by the relevant standard (or the relevant standard can be modified to accommodate such higher HARQ retransmissions during SOS).

Finally, process 300 proceeds to step 324, which includes transmitting the SOS message according to the coordinated SOS transmit parameters. In an embodiment, where the coordinated SOS transmit parameters are common to the SOS group, each member of the SOS group uses the same SOS transmit parameters to transmit the SOS message. A base station of the cellular network receives the SOS message transmissions at substantially the same time (or within a cyclic prefix of each other) and on the same or substantially the same frequency resources, and can combine the SOS message transmissions to decode the SOS message. The base station does not need to know that the SOS message transmissions are from multiple UEs, making this transmission mode transparent to the network. In another embodiment, where the coordinated SOS transmit parameters are member-specific, members of the SOS group may use different transmit parameters to transmit the SOS message. The base station may receive the SOS message transmissions at same/different times and/or on same/different frequency resources. Also, the SOS message transmissions may include different portions of the SOS message. Depending on the SOS transmit parameters used, the base station may need to know that cooperative transmission is taking place in order to decode the SOS message, making this transmission mode non-transparent to the network in certain cases.

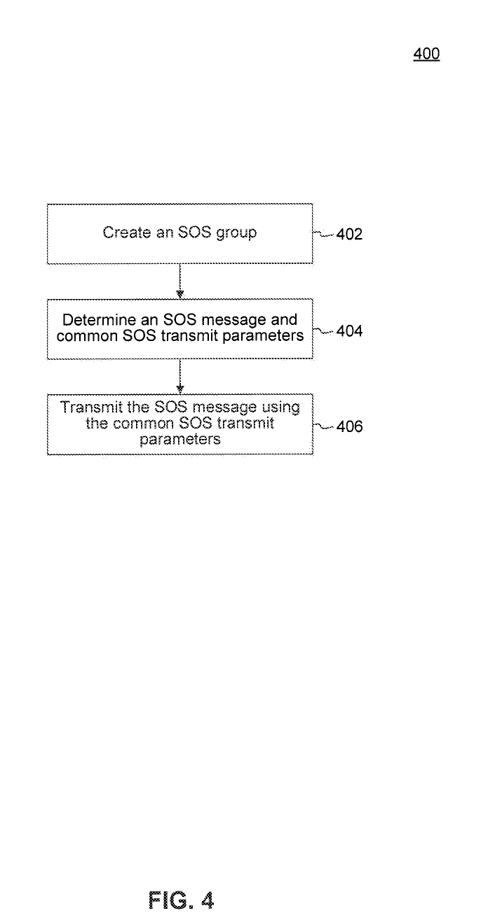

FIG. 4 is another example process 400 for cooperatively transmitting an SOS message to a cellular network. Example process 400 is provided for the purpose of illustration only and is not limiting of embodiments. Example process 400 can be performed by an SOS group to transmit an SOS message transparently to the network.

As shown in FIG. 4, process 400 begins in step 402, which includes creating an SOS group. In an embodiment, step 402 includes performing steps 208 and 210 of example process 200 described with reference to FIG. 2 above and/or steps 302, 304, 306, 310, and 312 of example process 300 described with reference to FIG. 3 above.

Subsequently, process 400 proceeds to step 404, which includes determining an SOS message and common SOS transmit parameters. In an embodiment, step 404 includes performing steps 318 and 322 described with reference to FIG. 3 above. In another embodiment, step 404 further includes receiving capabilities of the members of the SOS group and selecting the common SOS transmit parameters in accordance with the received capabilities. Finally, process 400 terminates in step 406, which includes transmitting the SOS message using the common SOS transmit parameters. In an embodiment, the common SOS transmit parameters include at least one of a common transmission time, common transmit frequency resources, a common power level, a common channel coding scheme, a common modulation scheme, and a common incremental redundancy (IR) version for transmitting the SOS message.

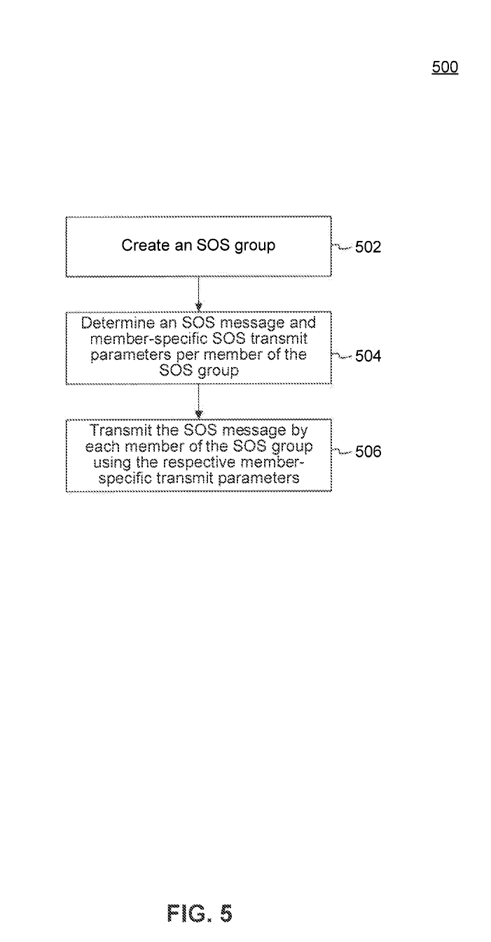

FIG. 5 is another example process 500 for cooperatively transmitting an SOS message to a cellular network. Example process 500 is provided for the purpose of illustration only and is not limiting of embodiments. Example process 500 can be performed by an SOS group to transmit an SOS message to the network.

As shown in FIG. 5, process 500 begins in step 502, which includes creating an SOS group. In an embodiment, step 502 includes performing steps 208 and 210 of example process 200 described with reference to FIG. 2 above and/or steps 302, 304, 306, 310, and 312 of example process 300 described with reference to FIG. 3 above.

Subsequently, process 500 proceeds to step 504, which includes determining an SOS message and member-specific SOS transmit parameters per member of the SOS group. In an embodiment, step 504 includes performing steps 318 and 322 described with reference to FIG. 3 above. In another embodiment, step 504 further includes receiving capabilities of the members of the SOS group and selecting the member-specific SOS transmit parameters in accordance with the received capabilities of each member. Finally, process 500 terminates in step 506, which includes transmitting the SOS message by each member of the SOS group using its respective member-specific SOS transmit parameters. In an embodiment, the member-specific SOS transmit parameters include at least one of a member-specific transmission time, member-specific transmit frequency resources, a member-specific power level, a member-specific channel coding scheme, a member-specific modulation scheme, and a member-specific IR version for transmitting the SOS message. In an embodiment, each member of the SOS group selects some of its member-specific SOS transmit parameters, while other member-specific SOS transmit parameters are coordinated among the SOS group. For example, in an embodiment, the member-specific transmission time, transmit frequency resources, and IR version are coordinated among the SOS group, and the other parameters are determined by the group member.

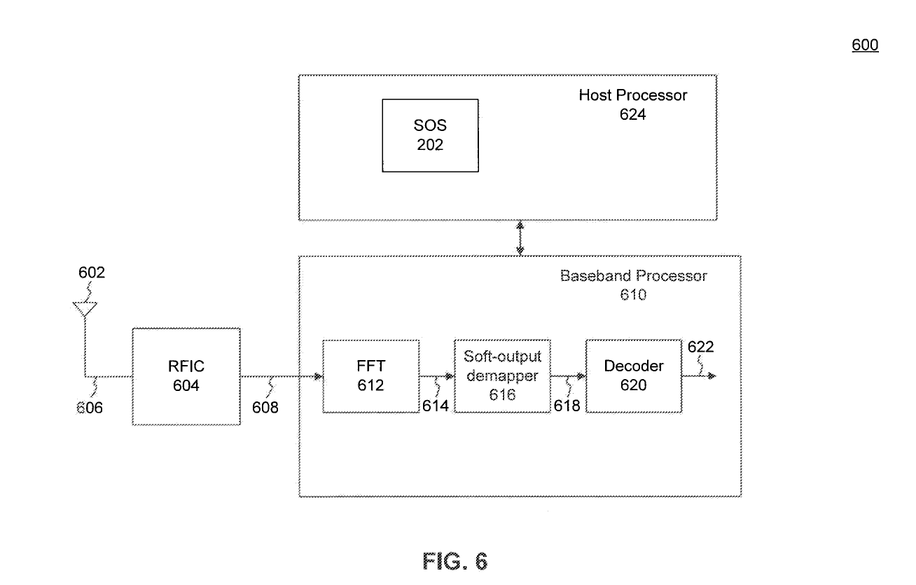

In another aspect of embodiments, a group of UEs located in proximity to each other, such as UEs 110a-d, can coordinate to form an SOS group and then to receive cooperatively using the formed SOS group. For the purpose of illustration only, an example UE 600 which can be used to perform cooperative reception according to embodiments is provided in FIG. 6.

As shown in FIG. 6, example UE 600 includes a radio frequency integrated circuit (RFIC) module 604, a baseband processor 610, and a host processor 624. RFIC 604 may include various analog components such as mixers and low pass filters, and mixed signal components such as analog-to-digital converters (ADCs) and digital-to-analog converters (DACs). RFIC 604 is configured to receive an analog signal 606 from an antenna 602 and to generate a digital signal 608. Baseband processor 610 includes a Fast Fourier Transform (FFT) module 612 configured to generate an FFT output 614 based on digital signal 608, a soft-output demapper 616 configured to generate soft bits 618 based on FFT output 614, and a decoder 620 configured to generate a bit sequence 622 based on soft bits 618. Host processor 624 is configured to host SOS application 202 described above with reference to FIG. 2 above. In addition, host processor 624 may host an operating system and other various applications as would be apparent to a person of skill in the art. In other embodiments, UE 600 may further include non-cellular communication modules, such as a GNSS receiver, a WiFi chip, a Bluetooth chip, etc.

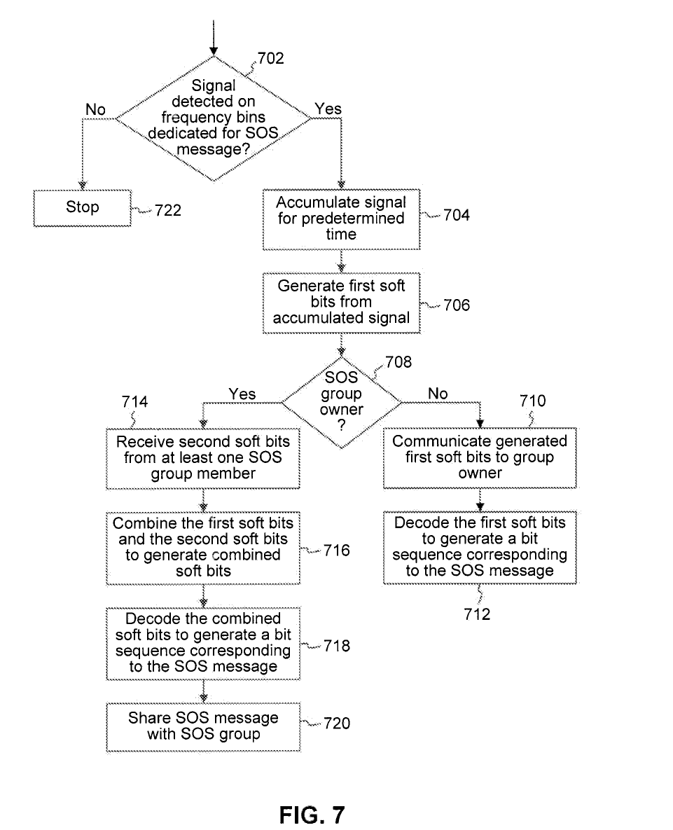

FIG. 7 is an example process 700 for cooperatively receiving an SOS message from a cellular network by an SOS group according to an embodiment. Example process 700 is provided for the purpose of illustration only and is not limiting of embodiments. Example process 700 can be performed by an SOS group member using a UE, such as example UE 600, for example. In an embodiment, example process 700 is performed after transmitting an SOS message to the network to receive an SOS response from the network.

As shown in FIG. 7, process 700 begins in step 702 which includes determining whether or not a signal is detected on frequency bins dedicated for the SOS message from the cellular network. In an embodiment, the cellular network dedicates frequency resources for sending SOS messages (or SOS responses) from the network, and step 702 includes examining the output of an FFT module (e.g., FFT module 614) to determine if a signal is present on the dedicated frequency resources.

If no signal is detected in step 702, process 700 proceeds to step 722, where it terminates. Otherwise, process 700 proceeds to step 704, which includes accumulating the detected signal for a predetermined time. Subsequently, process 700 proceeds to step 706, which includes generating first soft bits from the accumulated signal. In an embodiment, step 706 is performed by a soft-output demapper, such as soft-output demapper 616.

Then, process 700 proceeds to step 708, which includes determining whether or not the SOS group member is the SOS group owner. If the SOS group member is not the SOS group owner, process 700 proceeds to step 710, which includes communicating the generated first soft bits to the SOS group owner, and then to step 712, which includes decoding the first soft bits to generate a bit sequence corresponding to the SOS message transmitted by the cellular network. In an embodiment, depending on the generated first soft bits, step 712 may or may not be performed. For example, the generated first soft bits may not be sufficient for decoding the SOS message.

If the SOS group member is the group owner in step 708, process 700 proceeds to step 714, which includes receiving second soft bits from at least one SOS group member. The received second soft bits may corresponds to the first soft bits communicated to the group owner in step 710.

Then, in step 716, process 700 includes combining the first soft bits and the second soft bits to generate combined soft bits. In an embodiment, because the first soft bits and the second soft bits correspond to the same SOS message, step 716 includes adding, soft bit by soft bit, the first soft bits and the second soft bits to generate the combined soft bits. Subsequently, process 700 proceeds to step 718, which includes decoding the combined soft bits to generated a bit sequence corresponding to the SOS message transmitted by the cellular network. The combined soft bits provide a better probability of decoding the SOS message than the first soft bits and the second soft bits decoded separately.

Finally, process 700 terminates in step 720, which includes sharing the SOS message with the SOS group. This includes the SOS group owner sending the decoded SOS message to other members of the SOS group.

In a further aspect, embodiments provide a scheme for enabling dedicated receivers, such as receiver 112 in example environment 100, and/or UEs that are attached to the cellular network, such as UEs 106 and 108 in example environment 100, to serve as relay stations for SOS messages, thereby extending the coverage of the cellular network to the emergency area. For example, as shown in FIG. 1, UE 106 can be configured to bridge the connection between USE 110b and eNodeB 102. Similarly, dedicated receiver 112 can be configured to receive SOS messages, and accordingly can receive an SOS message from UE 110c and relay the SOS message to eNodeB 104. As will be understood based on the teachings herein, relay stations can serve to bridge the connection in both directions between UEs 110a-d and the eNodeBs.

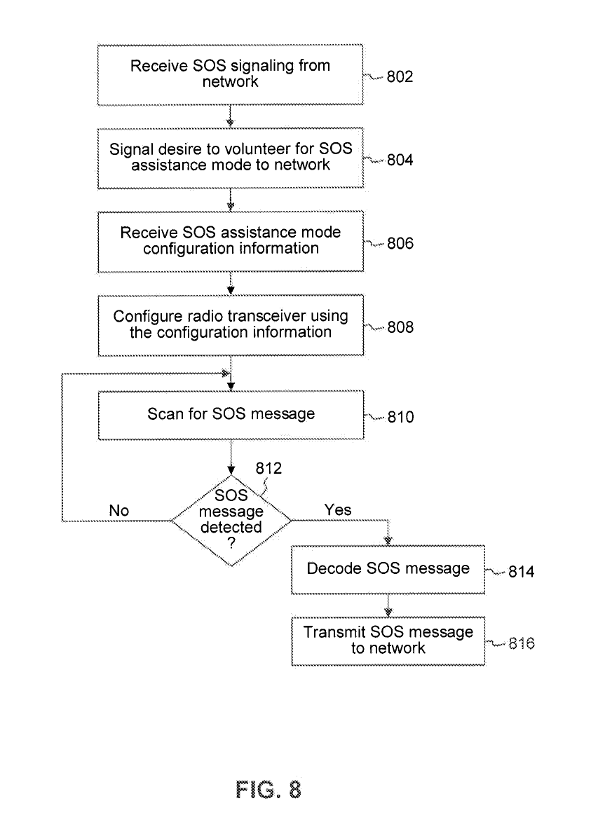

FIG. 8 is an example process 800 for enabling a UE to relay an SOS message to a cellular network according to an embodiment. Example process 800 is provided for the purpose of illustration only and is not limiting, of embodiments. Example process 800 can be performed by any UE capable of receiving and decoding control signaling from the cellular network. For example, UEs 106 and 108 can perform process 800 to act as relay nodes to extend the cellular network coverage into emergency area 116. Similarly, process 800 can be performed by dedicated receiver 112. In another embodiment, dedicated receiver 112 can be pre-configured for receiving and relaying SOS messages and does not need to perform process 800 in order to receive and relay SOS messages. As will be understood by a person of skill in the art based on the teachings herein, example process 800 can be used by a UE to receive an SOS message transmitted by a single UE or cooperatively by multiple UEs.

As shown in FIG. 8, process 800 begins in step 802, which includes receiving SOS signaling from the cellular network. In an embodiment, the SOS signaling is received by the UE over a downlink control channel of a serving base station of the UE. In an embodiment, the SOS signal is transmitted by the serving base station over predefined subcarriers, which can be dedicated for SOS signaling. For example, in an embodiment, a predefined bit is used to identify whether or not SOS signaling is contained in a next radio frame of the downlink control channel. When the predefined bit is set, the UE can receive the SOS signaling over the predefined subcarriers during the next radio frame. In an embodiment, the SOS signaling includes a call for SOS assistance mode volunteers and can identify a geographic area where assistance is needed. In an embodiment, the geographic area encompasses an emergency area. In another embodiment, the geographic area further encompasses areas that are near the emergency area, such as areas that are within a percentage (e.g., 50%, 15%, etc.) of a typical UE's radio range from the emergency area.

Subsequently, process 800 proceeds to step 804, which includes signaling a desire to volunteer for SOS assistance mode to the cellular network. In an embodiment, the SOS signaling information can be processed by an SOS application (e.g., SOS application 202) at the UE, and if the LIE is within the identified geographic area the SOS application can prompt the user to respond to the call for SOS assistance mode volunteers. If the user responds positively to the SOS application prompt, the UE transmits uplink signaling to the cellular regarding its desire to volunteer for SOS assistance mode. In an embodiment, the user can configure the SOS application to enable/disable automatic processing of SOS signaling from the cellular network.

Then, in step 806, process 800 includes receiving SOS assistance mode configuration information from the cellular network. In an embodiment, the SOS assistance mode configuration information is received by the UE over the downlink control channel of the serving base station of the UE. In an embodiment, the SOS assistance mode configuration information includes any information necessary for configuring the UE to receive SOS messages from other UEs. For example, the SOS assistance mode configuration information can include information regarding time/frequency resources, a channel coding scheme, a modulation scheme, an SOS message format, a scrambling scheme, or any other parameter used for transmitting SOS messages. Additionally, the SOS assistance mode configuration can include algorithms (e.g., search algorithms) used to locate and detect SOS messages. Example SOS message transmission/reception schemes can be found in commonly owned U.S. patent application Ser. No. TBD, filed Mar. 15, 2013, titled “Synchronous SOS Messaging in a Cellular Network,” (Attorney Docket. No. 3875.6720001), which is incorporated herein by reference in its entirety. According to embodiments, any of the transmission/reception parameters used in these schemes can also be included in the SOS assistance mode configuration information.

Subsequently, process 800 proceeds to step 808, which includes configuring as radio transceiver of the DE using the SOS assistance, mode configuration information. Then, in step 810, process 800 includes scanning for an SOS message. In an embodiment, step 810 includes accumulating and examining the output of an FFT module (e.g., FFT module 614) to determine if a signal is present on time/frequency resources designated for SOS messages.

Then, step 812 includes determining whether or not an SOS message has been detected. If no SOS message is detected, process 800 returns to step 810. Otherwise, process 800 proceeds to step 814, which includes decoding the SOS message, and then to step 816, which includes transmitting the SOS message to the cellular network. In another embodiment, the SOS message content can be revealed to the UE's user, who can make appropriate calls to emergency personnel.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure should not be limited by any of the above-described exemplary embodiments, but should be defined only in accordance with the following claims and their equivalents.

What is claimed is:

1. A method for cooperatively transmitting an emergency (SOS) message to a cellular network, comprising:
creating an SOS group with one or more neighboring peers;
coordinating transmit parameters for the SOS message with the SOS group; and
transmitting the SOS message according to the coordinated transmit parameters.

2. The method of claim 1, wherein creating the SOS group comprises:
determining a list of neighboring peers in response to enabling an SOS mode;
selecting the one or more neighboring peers from the list of neighboring peers; and
sending an invitation to the one or more neighboring peers to join the SOS group.

3. The method of claim 1, further comprising sending the SOS message to at least one member of the SOS group.

4. The method of claim 1, wherein the SOS message comprises Global Navigation Satellite System (GNSS) coordinates of at least one member of the SOS group.

5. The method of claim 1, further comprising performing at least one of time synchronization and frequency synchronization with at least one member of the SOS group.

6. The method of claim 1, wherein coordinating the transmit parameters for the SOS message comprises:
determining common SOS transmit parameters for the SOS message for the SOS group, and
wherein transmitting the SOS message according to the coordinated transmit parameters comprises transmitting the SOS message according to the common SOS transmit parameters.

7. The method of claim 6, wherein the common SOS transmit parameters include at least one of a common transmission time, common transmit frequency resources, a common power level, a common channel coding scheme, a common modulation scheme, and a common incremental redundancy (IR) version for transmitting the SOS message.

8. The method of claim 1, wherein coordinating the transmit parameters for the SOS message comprises:
determining member-specific SOS transmit parameters per member of the SOS group, and
wherein transmitting the SOS message according to the coordinated transmit parameters comprises transmitting the SOS message according to respective member-specific SOS transmit parameters.

9. The method of claim 8, wherein the member-specific SOS transmit parameters include at least one of a member-specific transmission time, member-specific transmit frequency resources, a member-specific power level, a member-specific channel coding scheme, a member-specific modulation scheme, and a member-specific incremental redundancy (IR) version for transmitting the SOS message.

10. The method of claim 9, wherein the member-specific power level is higher than a maximum power level allowed by a relevant communication standard or the member-specific channel coding scheme is of a lower rate than a minimum coding rate allowed by the relevant communication standard.

11. A method for cooperatively receiving an emergency (SOS) message from a cellular network by an SOS group, comprising:
detecting, by a member of the SOS group, a signal on frequency resources dedicated for SOS messaging from the cellular network; and
generating first soft bits from the detected signal, and
wherein if the member is the owner member of the SOS group, the method further comprising:
receiving second soft bits from at least one member of the SOS group;
combining the first soft bits and the second soft bits to generate combined soft bits; and
decoding the combined soft bits to generate a first bit sequence corresponding to the SOS message.

12. The method of claim 11, wherein if the member is not an owner member of the SOS group, the method further comprising:
communicating the first soft bits to the owner member of the SOS group; and
decoding the first soft bits to generate a second bit sequence corresponding to the SOS message.

13. The method of claim 11, wherein the first soft bits and the second soft bits correspond to a same portion of the SOS message.

14. The method of claim 11, wherein the first soft bits and the second soft bits correspond to different portions of the SOS message.

15. The method of claim 11, wherein if the member is the owner member of the SOS group, the method further comprising:
generating the SOS message from the first bit sequence; and
sharing the SOS message with the SOS group.

16. A method for enabling a user equipment (UE) to relay an emergency (SOS) message to a cellular network, comprising:
receiving, by the UE, SOS signaling from the cellular network;
signaling to the cellular network a desire to volunteer for SOS mode assistance, in response to the SOS signaling;
receiving SOS assistance mode configuration information from the cellular network; and
configuring a radio transceiver of the UE using the SOS assistance mode configuration information.

17. The method of claim 16, further comprising:
detecting an SOS message using the configured radio transceiver;
decoding the SOS message using the SOS assistance mode configuration information; and
transmitting the SOS message to the cellular network.

18. The method of claim 16, wherein the SOS signaling includes a geographic area.

19. The method of claim 18, further comprising:
retrieving Global Navigation Satellite System (GNSS) coordinates from a GNSS receiver;
comparing the GNSS coordinates to the geographic area; and
signaling to the cellular network the desire to volunteer for SOS mode assistance if the GNSS coordinates fall within the geographic area.

20. The method of claim 16, wherein the SOS assistance mode configuration information include information regarding one or more of: time resources, frequency resources, a channel coding scheme, a scrambling scheme, and a modulation scheme used for sending SOS messages.

21. The method of claim 16, wherein receiving the SOS signaling from the cellular network comprises receiving the SOS signaling on a downlink control channel of a serving cell of the UE.
